(19) United States
(12) Patent Application Publication
(10) Pub. No.: US 2017/0060045 A1
(43) Pub. Date: Mar. 2, 2017

(54) IMAGE FORMING APPARATUS

(71) Applicant: CANON KABUSHIKI KAISHA, Tokyo (JP)

(72) Inventor: Tohru Nakaegawa, Nagareyama-shi (JP)

(21) Appl. No.: 15/243,205

(22) Filed: Aug. 22, 2016

(30) Foreign Application Priority Data
Aug. 31, 2015 (JP) 2015-171526

(51) Int. Cl. G03G 15/16

(52) U.S. Cl. CPC G03G 15/1665; G03G 15/80

(57) ABSTRACT

The image forming apparatus has a control unit executing image forming by choosing either one of modes including first and second modes, the first mode for setting a length of an interval region between images in between a first region of an intermediate transfer member is formed and a second region of the intermediate transfer member is formed to a first length and the second mode for setting the same to a second length, and the control unit sets the first length to such a length that a region of the intermediate transfer member after one rotation of the first region and at least a part of the second region are overlapped with each other and the second length to a length of one rotation or more and two rotations or less of the intermediate transfer member.

### BACKGROUND OF THE INVENTION

Field of the Invention

The present invention relates to an image forming apparatus such as a copying machine, a printer and the like using an electrophotography method or an electrostatic recording method.

Description of the Related Art

In the electrophotographic type or the electrostatic recording type of the image forming apparatus, a toner image is formed by using an electrostatic latent image formed on an image bearing member which is an electrophotographic photosensitive member (photosensitive member) or an electrostatic recording dielectric body developed using toner. As a method of transferring the toner image formed on the image bearing member to a transfer material such as paper, an intermediate transfer method can be cited in which the toner image is subjected to primary transfer from the image bearing member to an intermediate transfer member and then, subjected to secondary transfer to the transfer material.

An image forming apparatus of the intermediate transfer method for forming an image using the electrophotography method will be further described. In this image forming apparatus, the primary transfer of the toner image from the photoreceptor to the intermediate transfer member is performed by applying a primary transfer voltage to a primary transfer unit, such as a primary transfer roller, provided in correspondence with the photoreceptor through the intermediate transfer member, for example. For example, the secondary transfer of the toner image from the intermediate transfer member to the transfer material is performed by applying a secondary transfer voltage to a secondary transfer unit, such as a secondary transfer roller, arranged by facing the intermediate transfer member.

As the intermediate transfer member, the one obtained by molding a resin material into a seamless belt shape in which a conductive agent is added to the resin material so as to adjust an electrical resistance value to a desired value is used in many cases. Japanese Patent Application Laid-Open No. 2009-192901 and Japanese Patent Application Laid-Open No. 2007-316622 propose the apparatus with improved transfer efficiency during the secondary transfer by forming a surface layer with an excellent mold-releasing performance of the toner on a surface of the intermediate transfer member so that a uniform image with high density can be obtained even if a sheet with large surface roughness or a sheet with irregularity on the surface is used. As the material of the surface layer, the one whose resistance value is adjusted by adding a conductive agent in the resin material with low surface energy such as a fluorine modified resin or the like is used, for example.

For example, in the case of the intermediate transfer member having the surface layer as described above, an added amount of the conductive agent can be decreased, and a content ratio of the fluorine modified resin can be increased in order to improve the mold-releasing performance of the toner. However, if the added amount of the conductive agent is too small, the electrical resistance value on the surface of the intermediate transfer member rises, and a remaining electric charge accumulated on the surface of the intermediate transfer member by the secondary transfer unit does not attenuate easily. Then, as illustrated in FIG. 11, a charge history by the primary transfer unit and the second transfer unit remains on the surface of the intermediate transfer member after having passed through a secondary transfer portion N2 in some cases. At this time, if the charge history is large, dispersion of the toner image on the photoreceptor occurs depending on the charge history on the intermediate transfer member on an upstream of a primary transfer portion N1 in a moving direction (conveyance direction) of the intermediate transfer member, which causes an uneven image (stepped density). That is, there is a concern that an image defect (here, it also called a “ghost”) involved in the charge history on the intermediate transfer member is made obvious. In order to suppress occurrence of such a ghost, the added amount of the conductive agent is adjusted in some cases to a vicinity of a lower limit value at which the ghost does not occur.

Moreover, not only if surface resistance is high but also if an electrostatic capacitance of the surface layer is high, the charges of the intermediate transfer member do not attenuate easily. The electrostatic capacitance can be lowered by thickening the surface layer of the intermediate transfer member. However, from the viewpoint of manufacture or the like, thickening of the surface layer of the intermediate transfer member has a limitation. A surface layer forming method includes a method of applying hardening processing after a coating liquid for forming the surface layer is applied on a base member of the intermediate transfer member and dried. In this case, the larger the surface layer is thickened, the longer time is needed for drying and hardening, whereby manufacture efficiency is remarkably affected. Thus, an upper limit of the thickness of the surface layer is approximately 20 μm.

As described above, since the intermediate transfer member cannot be fabricated by paying attention only to suppression of a ghost in general, the ghost can occur easily depending on a type of the transfer member, for example.

As a unit for suppressing the charge history on the intermediate transfer member, a method of providing a destaticizing unit for removing the remaining electric charges on the intermediate transfer member after the secondary transfer process can be cited. However, if the destaticizing unit or a high-voltage power supply for applying a voltage to the destaticizing unit is provided specially, a cost increase and a size increase of the apparatus are incurred, which is not desirable.

### SUMMARY OF THE INVENTION

The present invention is an image forming apparatus having an image bearing member which bears a toner image, a moving endless intermediate transfer belt on which the toner image subjected to primary transfer in a primary transfer portion from the image bearing member and subjected to secondary transfer in a secondary transfer portion to a recording material is temporarily borne, a primary transfer roller arranged on an inner peripheral surface side of the intermediate transfer belt and in the primary transfer portion, a first power supply for applying a voltage to the primary transfer roller, a secondary transfer member arranged on an outer peripheral surface side of the intermediate transfer belt and in the secondary transfer portion, a second power supply for applying a voltage to the secondary transfer member; and in consecutive image forming for consecutively forming a toner image on a plurality of recording materials, an execution portion for executing either one of modes including a first mode for setting a distance between recording materials which is a distance in a moving direction of the recording materials in a region between one recording material and a subsequent recording material subsequent to the one recording material to a first length and a second mode for setting the same to a second length longer than the first length, the execution portion setting the distance between recording materials in the first mode so that a region of the intermediate transfer belt corresponding to the one recording material overlaps a region of the intermediate transfer belt corresponding to the recording material subsequent to the one recording material at least partially after one rotation, while setting the distance between recording materials in the second mode to a length of a peripheral length of the intermediate transfer belt or more and twice of the peripheral length or less so that the region of the intermediate transfer belt corresponding to the one recording material is not overlapped with the region of the intermediate transfer belt corresponding to the recording material subsequent to the one recording material after one rotation, and in the second mode, applying a voltage with a same polarity with that during the primary transfer to the primary transfer roller by the first power supply when the region of the intermediate transfer belt corresponding to the region between the recording materials passes through the primary transfer portion.

Further features of the present invention will become apparent from the following description of exemplary embodiments with reference to the attached drawings.

### BRIEF DESCRIPTION OF THE DRAWINGS

FIG. 1 is an outline sectional view of an image forming apparatus.

FIG. 2 is a schematic sectional view of an intermediate transfer belt.

FIG. 3 is a block diagram illustrating an outline control mode of an essential part of the image forming apparatus.

FIGS. 4A and 4B are schematic diagrams for describing a position of a region to which a toner image on the intermediate transfer belt is transferred.

FIG. 5 is a graph illustrating a relation between a surface potential of the intermediate transfer belt and a primary transfer current in a first mode.

FIG. 6 is a graph illustrating a relation between the surface potential of the intermediate transfer belt at a position affecting a ghost and the primary transfer current.

FIG. 7 is a graph illustrating the surface potentials of the intermediate transfer belt in comparison between a first mode and a second mode.

FIG. 8 is a graph illustrating a relation between the surface potential of the intermediate transfer belt and presence of occurrence of the ghost;

FIG. 9 is a flowchart of control in an example 1.

FIG. 10 is a flowchart of control in an example 3.

FIG. 11 is a schematic diagram for describing an occurrence mechanism of the ghost.

FIG. 12 is a schematic diagram of a ghost chart for evaluating a ghost level.

### DESCRIPTION OF THE EMBODIMENTS

Preferred embodiments of the present invention will now be described in detail in accordance with the accompanying drawings.

An image forming apparatus according to the present invention will be described below in more detail by referring to the attached drawings.

### Example 1

### 1. Entire Constitution and Operation of Image Forming Apparatus

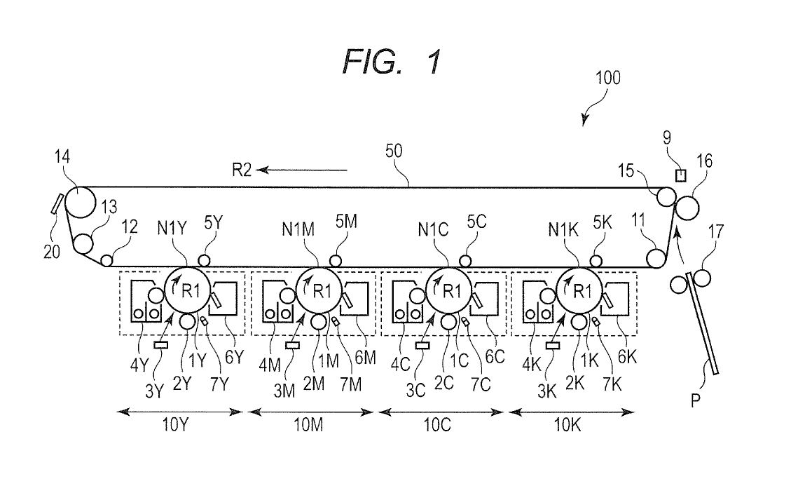

FIG. 1 is an outline sectional view of an image forming apparatus 100 according to an example of the present invention. The image forming apparatus of this example is a tandem-type laser-beam printer employing an intermediate transfer method capable of forming a full-color image using an electrophotography method.

The image forming apparatus 100 has first, second, third, and fourth image forming units 10Y, 10M, 10C, and 10K for forming images of yellow (Y), magenta (M), cyan (C), and black (K), respectively as a plurality of image forming units (stations). In this example, constitution and operations of each of the image forming units 10Y, 10M, 10C, and 10K are substantially the same except that a color of toner used in a development process which will be described later is different. Therefore, if discrimination is not particularly required, reference characters Y, M, C, and K at the end indicating that the character is an element in any of the colors are omitted, and the element is comprehensively described.

The image forming unit 10 has a photosensitive drum 1 which is a rotatable drum-type electrophotographic photoreceptor (photoreceptor) as an image bearing member. The photosensitive drum 1 is rotated/driven in an arrow R1 direction in the figure by a drum driving motor (not shown) as a photoreceptor driving unit. In this example, the photosensitive drum 1 is an organic photoconductor (OPC) drum having a photoreceptor layer of an organic substance on a conductive support body, and the conductive support body is electrically grounded. In the image forming unit 10, each of the following devices is arranged around the photosensitive drum 1. First, a charging roller 2 which is a roller-type charging member (charger) is arranged as a charging unit. Subsequently, an exposure device (laser scanner) 3 as an exposure unit is arranged. Subsequently, a development device 4 as a development unit is arranged. Subsequently, a primary transfer roller 5 which is a roller-type primary transfer member as a primary transfer unit is arranged. Subsequently, a drum cleaner 6 as a photoreceptor cleaning unit is arranged. Subsequently, a pre-exposure device 7 as a destaticizing unit is arranged.

A surface of the rotating photosensitive drum 1 is uniformly charged with a predetermined potential of a predetermined polarity (a negative polarity in this example) by the charging roller 2. After that, the exposure device 3 emits a laser beam according to an image signal, the light is collected on a bus line of the photosensitive drum 1, and by scanning/exposing the surface of the charged photosensitive drum 1, an electrostatic latent image (electrostatic image) is formed on the photosensitive drum 1. The electrostatic latent image formed on the photosensitive drum 1 is developed (visualized) by the development device 4 by using toner as a developer, and a toner image is formed on the photosensitive drum 1. In this example, the toner charged with the same polarity with the charging polarity of the photosensitive drum 1 adheres (reversal development) on an exposure portion on the photosensitive drum 1 whose absolute value of the potential lowers due to exposure after uniform charging processing. A predetermined amount of toner in yellow, magenta, cyan, and black is filled in each of the development devices 4Y, 4M, 4C, and 4K of each of the image forming units 10Y, 10M, 10C, and 10K, respectively.

An intermediate transfer belt 50 constituted by an endless belt as an intermediate transfer member is faced with each of the photosensitive drums 1Y, 1M, 1C, and 1K of each of the image forming units 10Y, 10M, 10C, and 10K. The intermediate transfer belt 50 is extended among idler rollers 11 and 12, a tension roller 13, a driving roller 14, and a backup roller 15 as a plurality of support rollers (stretching rollers) and stretched by a predetermined tension. The intermediate transfer belt 50 rotates (rotationally moves) in an arrow R2 direction in the figure when the driving roller 14 is rotated/driven by a belt driving motor 23 (FIG. 3) as an intermediate transfer member driving unit. Each of the aforementioned primary transfer rollers 5Y, 5M, 5C, and 5K is arranged in correspondence with each of the photosensitive drums 1Y, 1M, 1C, and 1K on an inner peripheral surface of the intermediate transfer belt 50. The primary transfer roller 5 is urged to the photosensitive drum 1 side through the intermediate transfer belt 50 and forms a primary transfer portion (primary transfer nip) N1 where the photosensitive drum 1 and the intermediate transfer belt 50 are brought into contact with each other. A secondary transfer roller 16 which is a roller-type secondary transfer member as a secondary transfer unit is arranged by facing the backup roller 15 on an outer peripheral surface side of the intermediate transfer belt 50. The secondary transfer roller 16 is urged toward the backup roller 15 through the intermediate transfer belt 50 and forms a secondary transfer portion (secondary transfer nip) N2 where the intermediate transfer belt 50 and the secondary transfer roller 16 are brought into contact with each other. In this example, the backup roller 15 is electrically grounded. A belt cleaner 20 as an intermediate transfer member cleaning unit is arranged by facing the driving roller 14 on the outer peripheral surface side of the intermediate transfer belt 50.

The toner image formed on the photosensitive drum as described above is electrostatically transferred (primary transfer) onto the intermediate transfer belt 50 at the primary transfer portion N1. At this time, a primary transfer voltage (primary transfer bias) with a different polarity to the charging polarity (normal charging polarity) of the toner at development is applied to the primary transfer roller 5 by a primary transfer power supply (high-voltage power circuit) 24 (FIG. 3) as a first applying unit. In forming of a full-color image, for example, toner images in four colors formed on each of the photosensitive drums 1Y, 1M, 1C, and 1K are sequentially transferred so as to overlap each other on the intermediate transfer belt 50 at each of primary transfer units N1Y, N1M, N1C, and N1K. The toner remaining on the surface of the photosensitive drum 1 (primary transfer remaining toner) after the primary transfer process is removed from the surface of the photosensitive drum 1 by the drum cleaner 6 and recovered in a toner recovery container (not shown). After that, the remaining charge on the photosensitive drum 1 is destaticized by the pre-exposure device 7.

The toner image formed on the intermediate transfer belt 50 is electrostatically transferred (secondary transfer) to a transfer material P at the secondary transfer portion N2. At this time, a secondary transfer voltage (secondary transfer bias) with a different polarity to the normal charging polarity of the toner is applied to the secondary transfer roller 16 by a secondary transfer power supply (high-voltage power circuit) 21 (FIG. 3) as a second applying unit. The transfer material P is fed by a feeding roller 17 as a transfer material supplying unit to the secondary transfer portion N2 by matching timing with the toner image on the intermediate transfer belt 50. An adhering matter such as the toner remaining after the secondary transfer process on the surface of the intermediate transfer belt 50 (second transfer remaining toner) is removed by the belt cleaner 20 from the surface of the intermediate transfer belt 50 and is recovered in the toner recovery container (not shown). The belt cleaner 20 has a cleaning blade as a cleaning member arranged in contact with the intermediate transfer belt 50 and scrapes the adhering matter such as the secondary transfer remaining toner from the surface of the intermediate transfer belt 50.

The transfer material P to which the toner image has been transferred is conveyed to a fixing device (not shown) as a fixing unit, where the toner image is melted/fixed (fixed), and then, it is discharged (output) to an outside of an apparatus device body of the image forming apparatus 100.

### 2. Intermediate Transfer Belt

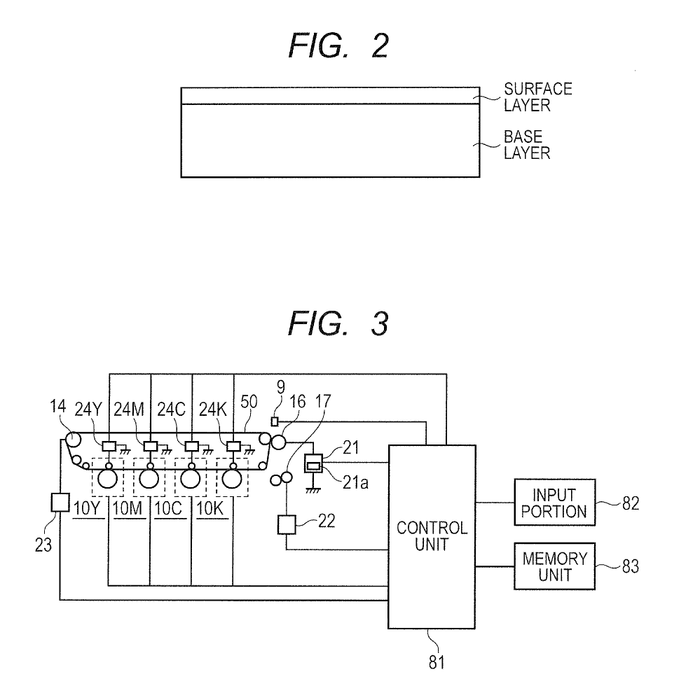

Subsequently, the intermediate transfer belt 50 in this example will be further described. FIG. 2 is a schematic sectional view of the intermediate transfer belt 50 in this example.

In this example, the intermediate transfer belt 50 has two layers, that is, a base layer and a surface layer. The intermediate transfer belt 50 may have another layer such as an intermediate layer or may be constituted to have a plurality of layers including the base layer and the surface layer. As a resin material used for the base layer of the intermediate transfer belt 50, any thermoplastic resin or thermosetting resin material can be suitably used. As the thermoplastic resin, polyethylene terephthalate (PET), polycarbonate (PC), polyamide (PA), polyphenylenesulfide (PPS), polyethersulfone (PES), poly ether ether ketone (PEEK) and the like can be used. As the thermosetting resin, polyimide (PI) and the like can be used. As the base layer of the intermediate transfer belt 50, a semiconductive belt obtained by adding an appropriate amount of carbon black or metal fine particles as a conductive agent to the aforementioned resin material and by adjusting a surface resistivity to 1×10¹⁰ to 1×10¹³Ω/□ can be suitably used. By setting the surface resistivity within the aforementioned range, the primary transfer of the toner image can be performed favorably. Moreover, an excessive charge given to a back surface (inner peripheral surface) of the intermediate transfer belt 50 in the primary transfer portion N1 can be attenuated sufficiently rapidly and the primary transfer of the subsequent color can be performed favorably. Moreover, the charge given to the surface (outer peripheral surface) of the intermediate transfer belt 50 in the second transfer portion N2 can be attenuated sufficiently rapidly in many cases, and the primary transfer next time can be performed favorably (charge history will be described in more detail later).

As a resin material used for the surface layer of the intermediate transfer belt 50, acryl, epoxy and phenol resins can be used suitably, and an UV-curable acrylic resin with high hardness and excellent abrasion resistance is particularly suitable. The material of the surface layer includes UV-curable acryl monomer, oligomer, and prepolymer, perfluoropolyether (PFPE) as a fluorine resin for giving mold releasing performance, and a conductive agent for resistance adjustment. As the conductive agent, metal oxides such as carbon black, zinc antimonite, zinc oxide, tin oxide, titanium oxide and the like can be cited.

### 3. Control Mode

FIG. 3 is an outline control block diagram of an essential part of the image forming apparatus 100 of this example. In this example, an operation of each part is controlled by a control unit (CPU) 81 provided in the apparatus body of the image forming apparatus 100.

To the control unit 81, an input portion 82 for transmitting an instruction from an operator or an instruction from an external terminal device connected to the image forming apparatus 100 via a communication line to the control unit 81 is connected. The input portion 82 transmits an instruction on print contents (number of prints, designation of a type of the transfer material P and the like), for example, to the control unit 81. Here, the type of the transfer material P refers to those that can be discriminated by an arbitrary index as a group of the transfer materials from another group of the transfer materials. The type of the transfer material P includes one of the arbitrary indexes including a basis weight, a type, and a brand being different. The type of the transfer material P refers to those generally discriminated from the others as having a similar characteristic in the field such as ordinary paper, coated paper, and a cardboard. The input portion 82 is an example of a type detecting unit for detecting the type of the transfer material P used in the consecutive image forming.

To the control unit 81, a memory unit (ROM) 83 is connected. The memory unit 83 is a memory storing an operation program of the image forming apparatus 100, and the control unit 81 controls the operation of the image forming apparatus 100 on the basis of the program.

Moreover, to the control unit 81, the primary transfer power supply 24, the secondary transfer power supply 21, the belt driving motor 23, a feeding motor 22 for driving the feeding roller 17 and the like are connected. In this example, the secondary transfer power supply (high-voltage power circuit) 21 includes a current detecting unit 21a in order to detect a voltage in proportion to a current flowing through the secondary transfer roller 16 as current value information and sends it to the control unit 81. The control unit 81 can control the secondary transfer voltage based on the information. Moreover, the image forming apparatus 100 has a temperature/humidity sensor 9 for detecting a temperature/humidity inside the apparatus body as a circumstance detecting unit for detecting at least one of circumstance in and outside of the image forming apparatus. In this example, the temperature and the relative humidity inside the apparatus body is detected by the temperature/humidity sensor 9, and an absolute moisture amount is calculated by the control unit 81.

Here, the image forming apparatus 100 executes a series of image output operations (job, print operation) for forming and outputting an image onto a single or a plurality of transfer materials P started by one start instruction. The job has an image forming process, a pre-rotation process, a sheet interval process when an image is to be formed on the plurality of transfer materials P, and a post-rotation process. The image forming process is a period of time for performing formation of an electrostatic latent image of the image to be actually formed and output onto the transfer material P, formation of a toner image, and the primary transfer and the secondary transfer of the toner image, and a period of time of image forming refers to this period. In more detail, the timing of image forming is varied depending on a position where each of the processes of the formation of the electrostatic latent image, the formation of the toner image, and the primary transfer and the secondary transfer of the toner image is performed. The pre-rotation process is a period of time for performing a preparation operation before the image forming process from an input of the start instruction to start of actual formation of the image. The sheet interval process is a period of time corresponding to an interval between the transfer material P and the transfer material P when the image forming is consecutively performed for the plurality of transfer materials P (consecutive image forming). The post-rotation process is a period of time for performing an organizing operation (preparation operation) after the image forming process. A period of time for non-image forming refers to a period other than the period of time for image forming and includes the pre-rotation process, the sheet interval process, the post-rotation process and moreover, a pre multi-rotation process which is a preparation operation when the power of the image forming apparatus 100 is turned on or at recovery from a sleep state and the like.

<Ghost>

Subsequently, a ghost which is a defective image caused by a charge history on the intermediate transfer belt 50 will be described.

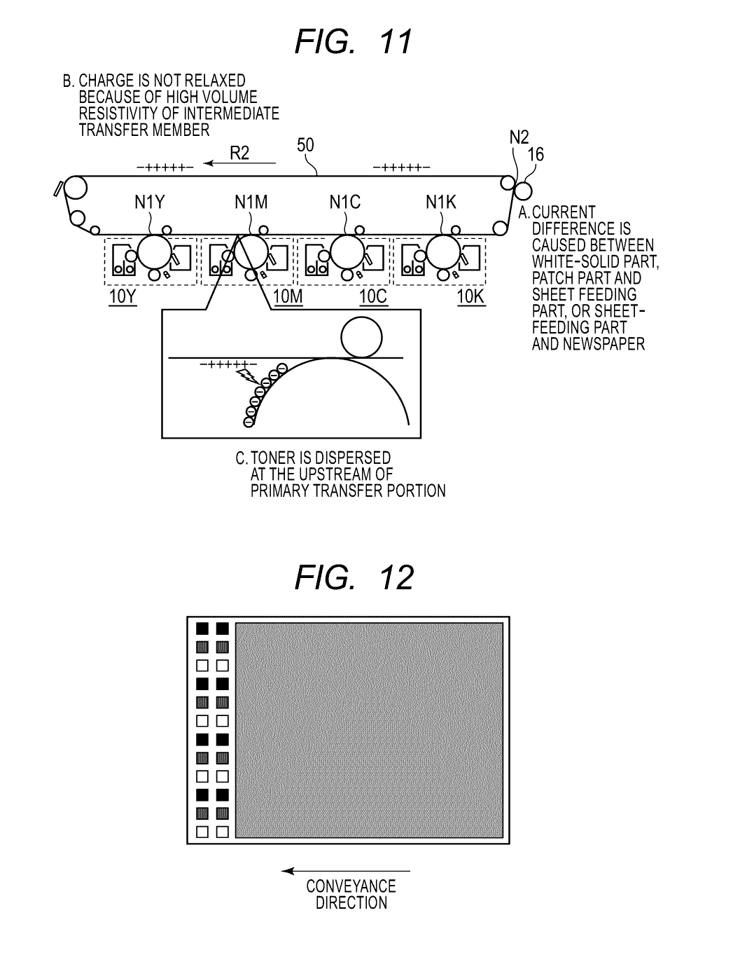

As described above, depending on the type of the transfer material P, a ghost can occur more easily in some cases. As described above by referring to FIG. 11, the charge history remains on the surface of the intermediate transfer belt 50 after passing through the secondary transfer portion N2, and the ghost occurs due to dispersion of the toner image on the photosensitive drum 1 on an upstream of the primary transfer portion N1 in accordance with this charge history. As the result of keen examination by the inventor, it was found that two types of ghosts could easily occur due to the following reasons.

First, a first type ghost will be described. When the secondary transfer of the toner image is consecutively performed for a plurality of the transfer materials P, the remaining charge amount accumulated on the surface of the intermediate transfer belt 50 can be suppressed by lowering the secondary transfer voltage in a sheet interval between the transfer material P and the transfer material P. However, at a leading edge portion of the transfer material P, the transfer material P needs to advance into the secondary transfer portion N2 after the secondary transfer voltage is reliably risen to a desired voltage, while at a rear edge portion of the transfer unit, the secondary transfer voltage needs to be lowered after the transfer material P passes through the secondary transfer portion N2. Thus, even if control is executed such that the secondary transfer voltage is lowered in the sheet interval as described above, the current supplied to the secondary transfer portion N2 increases at the leading edge portion and the rear edge portion of the transfer material P, a charged amount of the intermediate transfer belt 50 rises, and a ghost can occur easily. This phenomenon occurs more easily in a low-temperature and low-humidity circumstance in which a cardboard or a coated sheet with high basis weight is used as the transfer material P. That is because, the higher the basis weight is, the higher volume resistivity of the transfer material P rises, and the secondary transfer voltage is raised in order to cause a target current required for the transfer of the toner image to flow.

Subsequently, a second type of the ghost will be described. Depending on the type of the transfer material P, the volume resistivity can be largely different among the brands with the same basis weight. Here, the following experiment was conducted. That is, immediately after a chart in which a patch image and a half-tone image are combined as illustrated in FIG. 12 (hereinafter referred to as a “ghost chart”), an image of a whole-surface half-tone image is continuously formed. In this ghost chart, a plurality of patch images each having a substantially square shape is formed at an interval from each other within a predetermined range on a leading edge side in the conveyance direction. That is, within this range, patch images (patch parts) are scattered in a white-solid part. Moreover, in this ghost chart, the half-tone image is formed on substantially the whole remaining surface on the rear edge side from the patch images in the conveyance direction. The whole surface refers to an inside a region capable of forming an image on the transfer material P.

When the experiment as above was conducted, particularly if the volume resistivity of the transfer material P is low, it was found that a current difference between the patch part and the white-solid part on the transfer material P became larger, and a remaining charge amount difference on the surface of the intermediate transfer belt 50 tended to increase. As a result, if a whole-surface half-tone image is formed immediately after the ghost chart, a ghost can easily occur in the patch part with high surface potential of the intermediate transfer belt 50.

In the experiment by the inventor, when coated sheets such as OK Top Coat+ (Oji Paper Co., Ltd.) and Image Coat Gloss (Canon Inc.) with the basis weight of approximately 128 g/m² were used, a ghost occurred in some cases. The volume resistivity of these coated sheets was 2.3×10¹¹ Ω·cm for Image Coat Gloss and 3.0×10¹⁰ Ω·cm for OK Top Coat+, and the OK Top Coat+ with small volume resistivity had a poorer ghost level (see Table 1 which will be described later).

A digital super-high resistance/micro-current meter R8340/R8340A by Advantest Corporation was used for resistance measurement of the transfer material P, and the transfer material P immediately after opening was measured under a measurement condition of an applied voltage of 100 V and charging for 10 seconds.

<Suppression of Ghost>

The image forming apparatus 100 of this example can execute consecutive image forming in a first mode (normal sheet interval mode) and a second mode (extended sheet-interval mode) between which a length of the sheet interval in the moving direction of the intermediate transfer belt 50 (hereinafter referred to simply as a “length of the sheet interval”) is different. The first mode is a mode in which the length of the sheet interval is relatively short and a region on the intermediate transfer belt 50 to which one toner image is transferred and at least a part of a region to which a subsequent toner image is transferred are overlapped after one rotation of the intermediate transfer belt 50 in some cases. The length of the sheet interval in this first mode is shorter than one rotation of the intermediate transfer belt 50. The second mode is a mode in which the region on the intermediate transfer belt 50 to which the length of the sheet interval is relatively long and the one toner image is transferred is not overlapped with at least a part of the region to which the subsequent toner image is transferred after one rotation of the intermediate transfer belt 50. In this example, the length of the sheet interval in this second mode is one rotation or more and two rotations or less of the intermediate transfer belt 50. Moreover, in this example, a voltage with the same polarity with that during the primary transfer is continuously applied to the primary transfer portion N1 in the sheet interval in the second mode.

The second mode is chosen under a condition in which a ghost caused by the charge history on the intermediate transfer belt 50 can occur easily. Typically, the first mode or the second mode can be chosen on the basis of the type of a circumstance detected by a circumstance detecting unit or the transfer material detected by a type detecting unit. For example, if an absolute moisture amount is at a predetermined value or less or the type of the transfer material is a predetermined type with the predetermined basis weight or more, the second mode can be chosen. In more detail which will be described later, in the low-temperature and low-humidity circumstance (the absolute moisture amount is less than the predetermined value), if a predetermined coated sheet or a predetermined cardboard for which it is known in advance that a ghost can occur easily is used, the second mode is chosen. In this example, if the second mode is not chosen, the first mode is chosen. In the second mode, the length of the sheet interval is extended to one rotation or more and two rotations or less of the intermediate transfer belt 50 and the voltage with the same polarity with that during the primary transfer is continuously applied to the primary transfer portion N1 in the sheet interval, whereby the charge history accumulated on the surface of the intermediate transfer belt 50 can be suppressed. Typically, a potential difference between the intermediate transfer belt 50 and the surface potential of the photosensitive drum 1 on the upstream of the primary transfer portion N1 can be set to less than a discharge start voltage. As a result, occurrence of dispersion of the toner image on the upstream of the primary transfer portion N1 can be suppressed, and occurrence of a ghost can be suppressed. More detailed description will be given below.

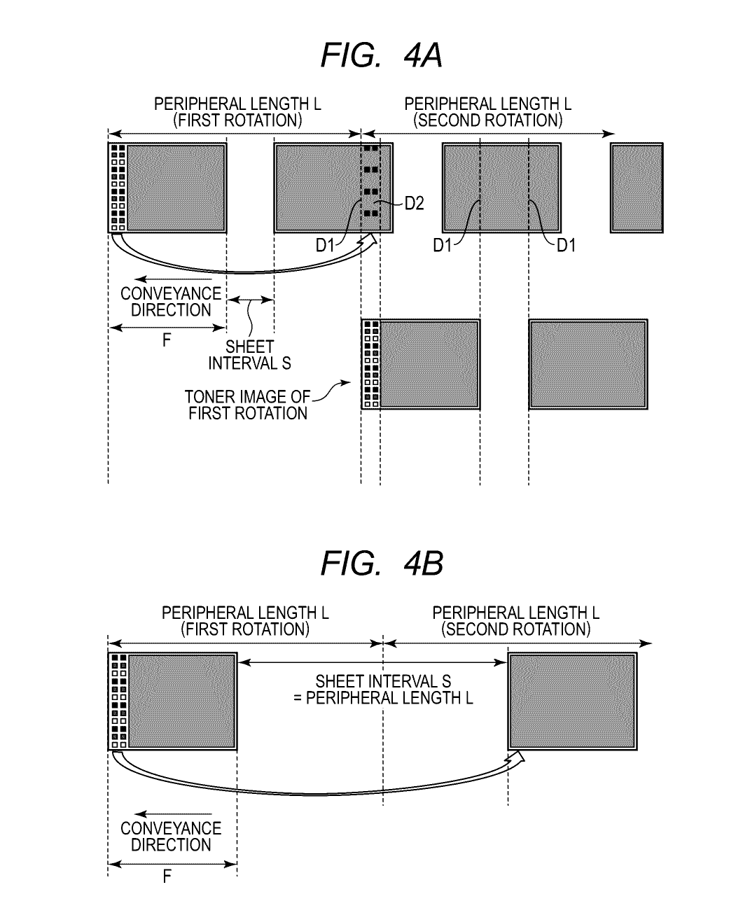

FIG. 4A is a schematic diagram illustrating a toner image (ghost chart) on the intermediate transfer belt 50 in the first mode and FIG. 4B is a schematic diagram illustrating the same in the second mode. FIGS. 4A and 4B both illustrate full-color modes. The case in the full-color modes will be described below as an example.

First, the first mode will be described. Diagrams on an upper side of FIG. 4A illustrate positions of toner images G subjected to consecutive primary transfer on the intermediate transfer belt 50 along the moving direction of the intermediate transfer belt 50. A length S of the sheet interval between the adjacent toner images G (a width of a region which is a distance between the sheets during the secondary transfer) is constant. In order to maximize printing capacity, the length S of the sheet interval is set to the shortest length that can be achieved in terms of constitution of the image forming apparatus 100. If a sum of a length F of the toner image in the conveyance direction and the length S of the sheet interval (F+S) is not an integer times of the peripheral length L of the intermediate transfer belt 50, the positions of the toner images do not become constant with respect to the intermediate transfer belt 50 between a first rotation of the intermediate transfer belt 50 and a second rotation and after. Normally, the peripheral length L of the intermediate transfer belt 50 is determined by considering a size of the image forming apparatus 100 or a running life of the intermediate transfer belt 50, and it does not become the integer times of F+S. In this example, it is L<(2F+S). Thus, in a region of the toner image G in the second rotation and after, a region D1 which was a leading edge portion as well as a rear edge portion of the transfer material P in the first rotation and a region D2 which was a white-solid part/patch part are overlapped with each other. This can be understood clearly in comparison with the position of the toner image G in the first rotation illustrated in diagrams on a lower side of FIG. 4A. As described above, on the surface of the intermediate transfer belt 50, if the charge amount at the leading edge portion and the rear edge portion of the transfer material P is excessive or a difference in the charge amount in the white-solid part/patch part is excessive, a ghost occurs in the regions D1 and D2.

In this example, the same voltage as that during the primary transfer is continuously applied to the primary transfer portion N1 in the sheet interval also in the first mode.

In the constitution of this example, it was found that if the transfer material P is ordinary paper with the basis weight less than 120 g/m² or a cardboard with the basis weight less than 220 g/m², a ghost did not occur. Therefore, in this example, if these transfer materials P are to be used, the image can be formed in the first mode. The first mode has a merit that a first job (print operation) can be finished in a shortest time.

Subsequently, the second mode will be described. In the second mode, as illustrated in FIG. 4B, the length S of the sheet interval which is the distance between the adjacent toner images G is extended to one rotation or more and two rotations or less of the intermediate transfer belt 50. Moreover, the voltage with the same polarity with that during the primary transfer is continuously applied to the primary transfer portion N1 in the sheet interval. Specifically, in the second mode, a voltage with the same setting (target current value) as that during the preceding primary transfer in the sheet interval is continuously applied to the primary transfer roller 5 in the sheet interval. In this example, the setting (target current value) of the primary transfer voltage applied during the primary transfer is supposed to be the same both in the first mode and in the second mode. Moreover, in this example, the voltage with the same setting (target current value) as that during the primary transfer is applied to all the primary transfer rollers 5Y, 5M, 5C, and 5K at this time. As a result, the charge history accumulated on the surface of the intermediate transfer belt 50 is suppressed. As a result, the surface potential of the intermediate transfer belt 50 can be maintained at a threshold value or less determined in advance, and occurrence of a ghost on the upstream of the primary transfer portion N1 can be suppressed.

Here, for the suppression of the charge history on the surface of the intermediate transfer belt 50, a sufficient effect can be obtained by extending the length S of the sheet interval to one rotation or more of the intermediate transfer belt 50. However, considering productivity of the image forming apparatus 100, it is not desirable to excessively extend the length S of the sheet interval. Therefore, an upper limit value of the length S of the sheet interval is set to two rotations or less of the intermediate transfer belt 50. Particularly in this example, the length S of the sheet interval in the second mode is set to one rotation of the intermediate transfer belt 50.

In the configuration of this example, it was known that a ghost can easily occur in the low-temperature and low-humidity circumstance with the absolute moisture amount at 0.9 g/m³ or less in an atmosphere and if the coated sheet with the basis weight at 106 g/m² or more is used as the transfer material P. Moreover, in the configuration of this example, it was known that a ghost can also easily occur in the low-temperature and low-humidity circumstance with the absolute moisture amount at 0.9 g/m³ or less in an atmosphere and if the cardboard with the basis weight at 220 g/m² or more is used as the transfer material P. Therefore, in this example, it was configured that the second mode is chosen in these cases so as to suppress occurrence of a ghost.

### 6. Measurement Result of Surface Potential

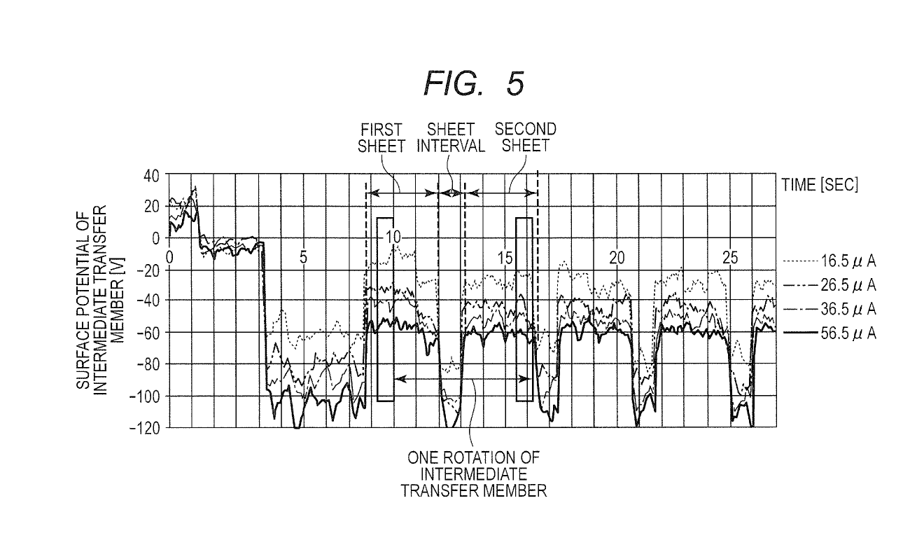

Subsequently, a result of measurement of the surface potential of the intermediate transfer belt 50 will be described by referring to FIGS. 5 to 7. The surface potential of the intermediate transfer belt 50 was measured as follows. The driving roller 14 is electrically grounded, and a surface potential meter is installed at a position faced with the driving roller 14 (a position of the belt cleaner 20) by separating it from the surface of the intermediate transfer belt 50 by approximately 1 mm. Then, the surface potential of the intermediate transfer belt 50 was measured by this surface potential meter while the image forming apparatus 100 was operating (while the intermediate transfer belt 50 is driving). As the surface potential meter, MODEL 344 by Trek Japan Inc. can be used, for example. A value of the primary transfer current is represented by the target current value (set value) in control of the primary transfer voltage. As the transfer material P, OK Top Coat+ with 128 g/m² for which ease of occurrence of a ghost was confirmed by tests of the inventor was used, and a test circumstance was set to a temperature of 23±2° C. and relative humidity of 6±1%. In both the first and second modes, the secondary transfer voltage applied to the secondary transfer portion N2 during the secondary transfer was fixed, and the secondary transfer voltage in the sheet interval was lowered than that during the secondary transfer (the same secondary transfer voltage as that during the secondary transfer from immediately before the leading edge of the image region to immediately after the rear edge).

FIG. 5 illustrates a result of measurement of the surface potential of the intermediate transfer belt 50 when the target value of the primary transfer current was changed and consecutive image forming (consecutive sheet feeding) of a white-solid image was performed in the first mode. The target values of the primary transfer current were set to 16.5 μA, 26.5 μA, 36.5 μA, and 56.5 μA.

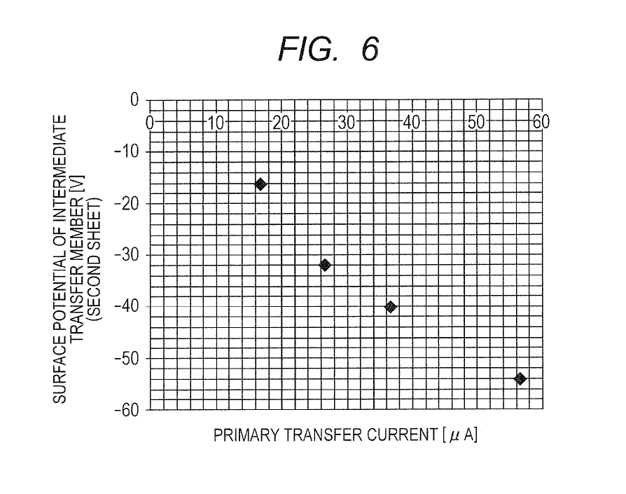

Moreover, FIG. 6 illustrates a relation between the surface potential of a region before one rotation of the intermediate transfer belt 50 overlapped with a second image region during the consecutive image forming when the result of FIG. 5 was obtained and the primary transfer current. The reason why the surface potential of the region before one rotation of the intermediate transfer belt 50 overlapped with the second image region during the consecutive image forming was chosen is as follows. That is because, as illustrated in FIG. 4A, a ghost occurring in the second image during the consecutive image forming is affected by the surface potential of the image region before one rotation of the intermediate transfer belt overlapping that position. The surface potential illustrated in FIG. 6 corresponds to the surface potential of a portion surrounded by a first frame in FIG. 5.

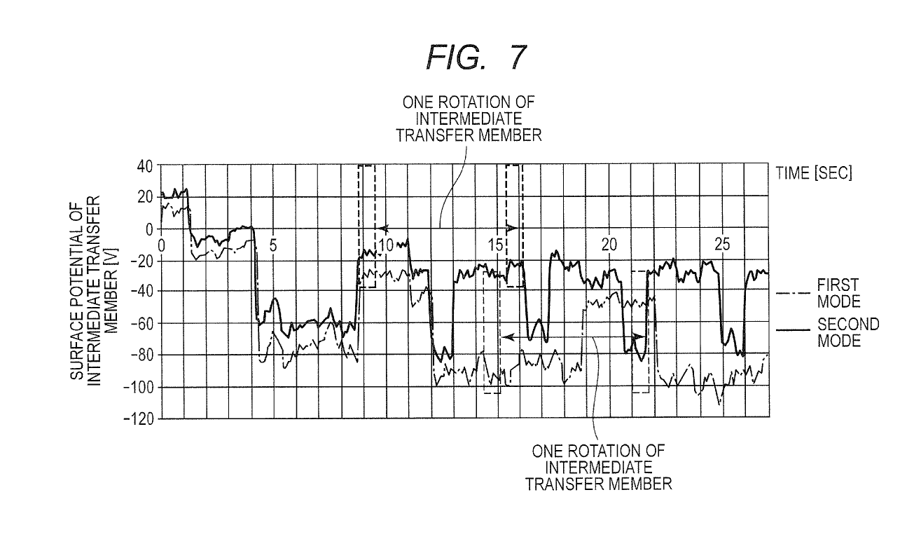

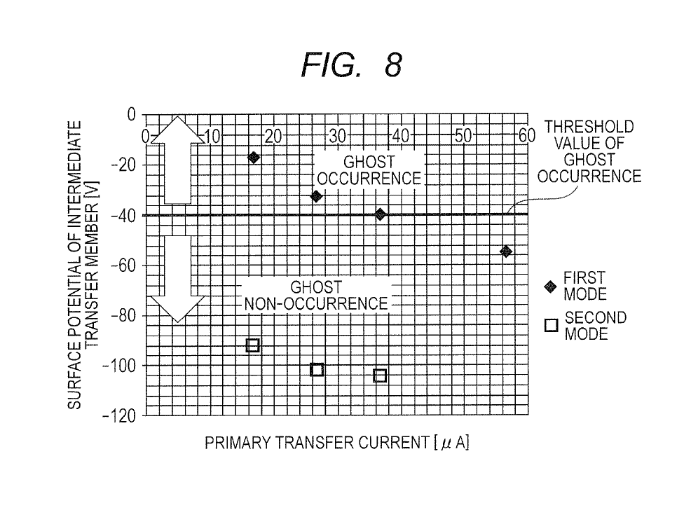

Moreover, FIG. 7 illustrates a result of comparison of the surface potential of the intermediate transfer belt 50 between a case in which the consecutive image forming was performed for a white-solid image in the first mode and a case in which the consecutive image forming was performed for a white-solid image in the second mode in accordance with this example.

From FIGS. 5 and 6, it is known that, when the secondary transfer current is fixed and the target value (optimal current value) of the primary transfer current is increased, the surface potential of the intermediate transfer belt 50 tends to decrease (increases to a normal charge polarity side of the toner). Moreover, from FIG. 7, it is known that the surface potential of the intermediate transfer belt 50 can be decreased (increased to the normal charge polarity side of the toner) in the second mode. Moreover, from FIG. 7, it can be confirmed that the region before one rotation of the intermediate transfer belt overlapping the second image region during the consecutive image forming is not affected by the secondary transfer portion N2 in the second mode. That is, in a graph of the second mode in FIG. 7, the surface potential of the region before one rotation of the intermediate transfer belt 50 overlapping the second image region during the consecutive image forming is sufficiently reduced.

FIG. 8 illustrates a relation between the surface potential of the region before one rotation of the intermediate transfer belt 50 overlapping the second during the consecutive image forming and presence of occurrence of a ghost. In the image forming apparatus 100 of this example, it was found that a ghost did not occur by setting the surface potential of the region before one rotation of the intermediate transfer belt 50 overlapping the second image region to −40 [V] (threshold value) or less if the consecutive image forming was performed for a white-solid image.

Thus, in this example, as a method of setting the surface potential of the intermediate transfer belt 50 to the threshold value or less of ghost occurrence, the second mode is used. In the second mode, the length of the sheet interval is extended to the whole peripheral of the intermediate transfer belt 50 and the same voltage as that during the primary transfer is continuously applied to the primary transfer portion N1 in the sheet interval. The second mode is used when a predetermined condition is met that the surface potential can become larger than −40 [V] (increases to the different polarity side to the normal charge polarity of the toner) if the first mode is used. As described above, this predetermined condition in this example is the low-temperature and low-humidity circumstance with the absolute moisture amount in the atmosphere at 0.9 g/m³ or less and the predetermined coated sheet or the predetermined cardboard is used as the transfer material P.

The threshold value of ghost occurrence is varied depending on a characteristic of the toner loaded in the image forming apparatus 100 or a characteristic of the material of the intermediate transfer belt 50 and is not limited to the numerical values in this example.

Moreover, in this example, the primary transfer voltage applied in the sheet interval is made the same as that during the primary transfer and thus, a trouble such as photosensitive drum memory which can occur due to an increase of a set value of the primary transfer current does not occur. Here, the photosensitive drum memory is a phenomenon that a charge history remains on the photosensitive drum 1 due to an influence of the primary transfer voltage, and image unevenness (density step) occurs in the subsequent image forming.

### 7. Control Flow

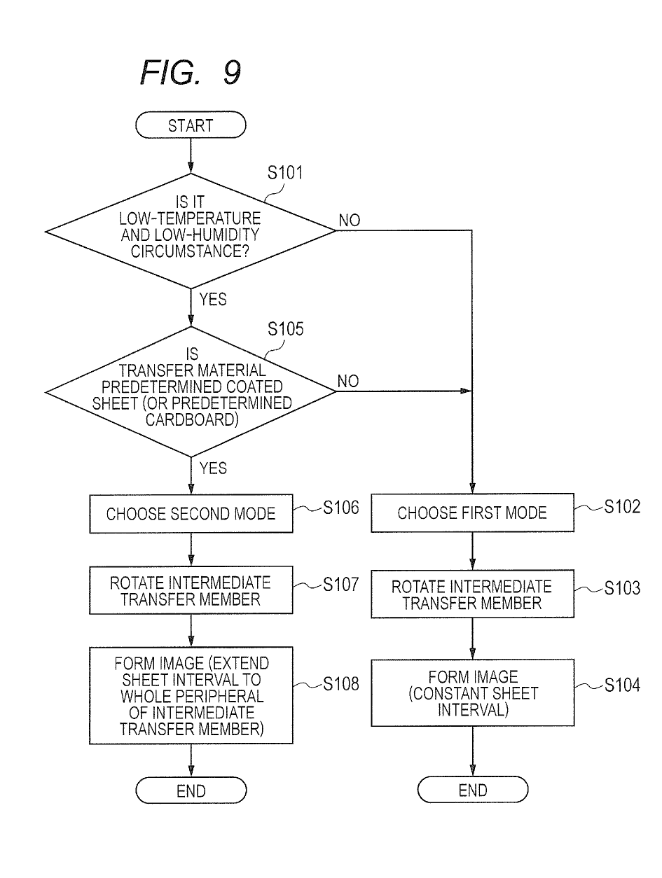

FIG. 9 is a flowchart illustrating an outline control flow of a job in this example.

First, the control unit 81 reads a detection result of the temperature/humidity sensor 9 when a job of the consecutive image forming is input and determines whether an installation circumstance of the image forming apparatus 100 is a low-temperature and low-humidity circumstance with the absolute moisture amount less than a predetermined amount or not (S101). If the control unit 81 determines at S101 that the circumstance is not the low-temperature and low-humidity circumstance (“No”), it chooses the first mode (S102). Alternatively, if the control unit 81 determines at S101 that the circumstance is the low-temperature and low-humidity circumstance (“Yes”), it determines whether the type of the transfer material P instructed by the input portion 82 is the predetermined coated sheet or the predetermined cardboard (S105). If the control unit 81 determines at S105 that the type is not the predetermined coated sheet or the predetermined cardboard (“No”), it chooses the first mode (S102). Alternatively, if the control unit 81 determines at S105 that the type is the predetermined coated sheet or the predetermined cardboard (“Yes”), it chooses the second mode (S106).

If the control unit 81 chooses the first mode at S102, it sets the sheet interval constant (shorter than one rotation of the intermediate transfer belt 50) and repeatedly forms an image at a time interval corresponding to the sheet interval (S103, S104). On the other hand, if the control unit 81 chooses the second mode at S106, it extends the sheet interval to the whole peripheral of the intermediate transfer belt 50 and repeatedly forms an image at the time interval corresponding to the sheet interval (S107, S108). At this time, the same voltage as that during the primary transfer is continuously applied to the primary transfer portion N1 in the sheet interval. Moreover, setting of the primary transfer voltage (target current value) applied during the primary transfer at this time and in the sheet interval is supposed to be the same as that in the first mode.

### 8. Test Result

A result of examination of the effect of this example is illustrated in Table 1. Table 1 is the result of examination of occurrence situation of a ghost by using the transfer materials P with largely different volume resistivity and the same basis weight and by conducting an output durability test of 10 k sheets of images for both the first mode and the second mode. The test conditions and the used intermediate transfer belt 50 are as follows.

<Test Conditions>

Test device: iR-ADV-05250 by Canon Inc. (the test was conducted by mounting an intermediate transfer belt described below)

Test environment: Temperature 23±2° C., relative humidity 6±1%

Transfer material: OK Top Coat+128 g/m², Image Coat 128 g/m² evaluation image: solid image (secondary color red, blue, green), ghost chart (secondary color red, blue, green)

Print mode: full-color mode

<Intermediate Transfer Belt>

(1) Constitution of Intermediate Transfer Belt

An intermediate transfer belt made of double-layer constitution of a base layer and a surface layer was used. A polyimide resin or a polyether ether ketone resin was used for the base layer, and a surface layer coat obtained by adding a fluorine resin to an acrylic resin was used for the surface layer. A thickness of the base layer was approximately 60 to 70 μm, and a thickness of the surface layer was approximately 5 to 7 μm. Surface resistivity after the surface layer coating was set to 1×10¹⁰ to 1×10¹³Ω/□, and the volume resistivity was 1×10¹¹ Ω·cm or less.

(2) Measurement Method of Electrical Resistance of Intermediate Transfer Belt

Measurement device: Hiresta-UP by Mitsubishi Chemical Analytech Co., Ltd.

Measurement probe: URS (guard electrode outer diameter φ 17.9 mm) by Mitsubishi Chemical Analytech Co., Ltd.

Measurement condition: Applied voltage 100 V, charge for 10 seconds

As is known from the result in Table 1, when the first mode was used, a ghost occurred after output of 10 k images for the coated sheet with the basis weight of 128 g/m². Particularly since the OK Top Coat+ has an extremely lower volume resistivity than the Image Coat Gloss with the same basis weight or other brands, a level of the ghost was poor. However, when the second mode was used, a ghost did not occur after output of 10 k images in any of the transfer materials P.

TABLE 1

| | Transfer | Transfer paper | Ghost evaluation result (◯: | |
|---|---|---|---|---|
| | paper | volume | No occurrence; Δ: Slight | |
| | basis weight | resistivity | occurrence; X: Occurrence) | |
| | (g/m²) | (Ω · cm) | First mode | Second mode |
| OK Top | 128 | 3.0 × 10¹⁰ | X | ◯ |
| Coat+ | | | | |
| Image Coat | 128 | 2.3 × 10¹¹ | Δ | ◯ |
| Gloss | | | | |

In this example, the first mode or the second mode is chosen on the basis of both the circumstance and the type of the transfer material P, but choice may be made on the basis of either one of them, and a corresponding ghost suppression effect can be obtained. In this example, it is so configured that the second mode is chosen when the predetermined coated sheet or the predetermined cardboard is chosen, but the second mode may be chosen only when the predetermined coated sheet is chosen or only when the predetermined cardboard is chosen. Moreover, regardless of the basis weight, the second mode is chosen when the coated sheet, the cardboard or either one of them is chosen. That is, the second mode can be chosen under a condition in which it is known in advance that a ghost can occur easily.

The voltage with the same polarity with that during the primary transfer is continuously applied to all the primary transfer rollers 5Y, 5M, 5C, and 5K in the sheet interval in this example. But a corresponding effect can be obtained by continuously applying the voltage with the same polarity with that during the primary transfer to at least one of the primary transfer rollers 5.

As described above, in this example, the control unit 81 chooses one of the first mode and the second mode. The first mode is for setting the length of an interval region between images to the first length and the second mode is for setting it to the second length and executes image forming in the consecutive image forming for consecutively forming images on the plurality of transfer materials. Here, the interval region between images is a region of images in between the first region of the intermediate transfer member 50 on which an image to be transferred to the one transfer material P is formed and the second region of the intermediate transfer member 50 on which an image to be transferred to the transfer material P subsequent to the one transfer material P is formed. The control unit 81 sets the first length to such a length that a region after one rotation of the intermediate transfer member 50 in the first region and at least a part of the second region are overlapped with each other. The control unit 81 also sets the second length to a length of one rotation or more and two rotations or less of the intermediate transfer member 50. In this example, the control unit 81 causes the primary transfer unit 5 to apply the voltage with the same polarity with that during the primary transfer by the first applying unit 24 when the interval region between images of the intermediate transfer member 50 passes through the primary transfer portion N1 to the primary transfer unit 5 in the second mode.

As described above, according to this example, occurrence of a defective image caused by the charge history on the intermediate transfer belt 50 can be suppressed. Moreover, necessity to provide a special destaticizing unit for removing the charges on the surface of the intermediate transfer belt 50 is reduced, and the constitution of the image forming apparatus 100 can be simplified.

### Example 2

Subsequently, another example of the present invention will be described. Basic constitution and operations of the image forming apparatus of this example are the same as those in the example 1. Therefore, in the image forming apparatus of this example, the same reference numerals are given to elements having the same or corresponding functions and constitutions as those of the image forming apparatus in the example 1, and detailed description will be omitted.

In the example 1, the voltage applied to the primary transfer portion N1 in the sheet interval is set to that during the primary transfer. However, the surface potential of the intermediate transfer belt 50 does not satisfy the threshold value of ghost occurrence locally due to uneven surface resistance of the intermediate transfer belt 50 in mass production in some cases.

Thus, in this example, as a method of reliably lowering the surface potential of the intermediate transfer belt 50 to the threshold value or less of ghost occurrence, the second mode as follows is used. In the second mode, the length of the sheet interval is extended to the whole peripheral of the intermediate transfer belt 50 and the following voltage with the same polarity with that during the primary transfer is continuously applied to the primary transfer portion N1 in the sheet interval. That is, in this example, the voltage applied to the primary transfer portion N1 during the primary transfer and in the sheet interval in the second mode has the same polarity and an absolute value larger (higher to the different polarity side of the normal charge polarity of the toner) than the voltage applied to the primary transfer portion N1 during the primary transfer and in the sheet interval in the first mode. In this example, the voltage applied to the primary transfer portion N1 is supposed to be the same during the primary transfer and in the sheet interval. Specifically, setting of the voltage (target current value) to be applied to the primary transfer roller 5 during the primary transfer and in the sheet interval in the second mode is made to have the same polarity and an absolute value larger (higher to the different polarity side of the normal charge polarity of the toner) than that in the first mode.

At this time, the setting of the primary transfer voltage to be applied to all the primary transfer rollers 5Y, 5M, 5C, and 5K may be made uniformly high or the setting of the primary transfer voltage to be applied to at least one primary transfer roller 5 may be made high. For example, the setting of the primary transfer voltage to be applied to the primary transfer roller 5Y may be made high only in the image forming unit 10Y for yellow in which a ghost is not conspicuous easily. Alternatively, the setting of the primary transfer voltage to be applied to each of the primary transfer rollers 5Y, 5M, 5C, and 5K may be independently (differently) high, respectively.

Here, the increase of the setting of the primary transfer voltage incurs a concern of the photosensitive drum memory and thus, when the setting of the primary transfer voltage is to be switched, a non-image portion potential (charge potential) Vd of the photosensitive drum 1 can be also switched in correspondence with that. For example, if the setting of the primary transfer voltage is to be made higher to the different polarity side of the normal charge polarity of the toner (the absolute value of the voltage with positive polarity is increased in this example), that can be performed as follows. The non-image portion potential Vd of the photosensitive drum 1 is also made higher to the different polarity side to the charge polarity (the absolute value of the charge potential with negative polarity is made smaller in this example). That is, in the second mode, the non-image portion potential on the image bearing member is set to a potential with a small absolute value with the same polarity with the non-image portion potential on the image bearing member in the first mode. Typically, a potential difference between the non-image portion potential Vd and the primary transfer voltage is made substantially the same before and after the switching.

In this example, the voltage applied to the primary transfer portion N1 during the primary transfer and in the sheet interval in the second mode is set higher than that in the first mode, but only the voltage applied to the primary transfer portion N1 in the sheet interval may be made higher than that in the first mode.

As described above, according to this example, the occurrence of the defective image caused by the charge history on the intermediate transfer belt 50 can be suppressed more reliably even if the surface potential of the intermediate transfer belt 50 is locally different.

### Example 3

Subsequently, another example of the present invention will be described. Basic constitution and operations of the image forming apparatus of this example are the same as those in the example 1. Therefore, in the image forming apparatus in this example, too, the same reference numerals are given to elements having the same or corresponding functions and constitutions as those of the image forming apparatus in the example 1, and detailed description will be omitted.

In this example, information relating to electrical resistance of the transfer material P is used as a determination standard for choosing the second mode instead of the type (basis weight, type) of the transfer material P. That is, the first mode or the second mode is chosen on the basis of the information relating to the electrical resistance of the transfer material P detected by a resistance detecting unit. Particularly in this example, a current value flowing at a margin of the leading edge of the transfer material P by application of the voltage in the secondary transfer portion N2 is used as the determination standard.

That is, as described above, even if the type and the basis weight of the transfer material P are the same, a ghost can easily occur in a brand of the transfer material P with an extremely low volume resistivity. Thus, ease of ghost occurrence can be determined on the basis of the information relating to the electrical resistance of the transfer material P or particularly on the basis of the current value flowing at the margin of the leading edge of the transfer material P by application of the voltage in the secondary transfer portion N2 in this example.

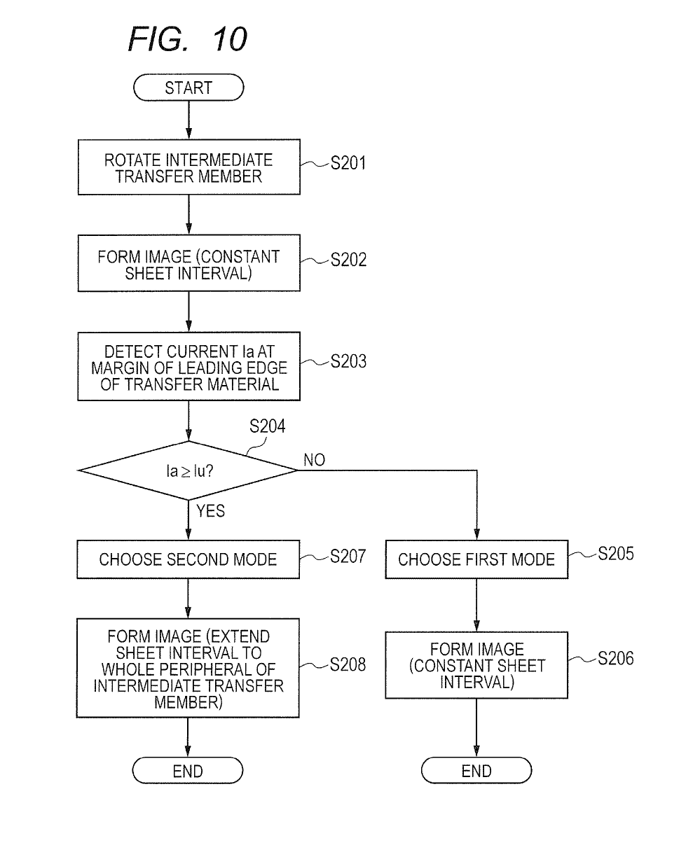

FIG. 10 is a flowchart illustrating an outline control flow of a job in this example.

First, when a job of the consecutive image forming is input, the control unit 81 starts forming of a first image by setting in the sheet interval in the first mode (S201, S202). Subsequently, the control unit 81 detects a current value Ia flowing at the margin of the leading edge of the transfer material P (S203) when the first transfer material P passes through the secondary transfer portion N2 by applying the predetermined secondary transfer voltage to the secondary transfer roller 16. In this example, as described above, a current detecting unit 21a provided in the secondary transfer high-voltage power supply (high-voltage power circuit) 21 detects a voltage in proportion to the current flowing through the secondary transfer roller 16 as current value information and sends it to the control unit 81. The current detecting unit 21a is an example of the resistance detecting unit for detecting the information relating to electrical resistance of the transfer material P used in the consecutive image forming. The control unit 81 determines whether the detected current value Ia is at a predetermined value Iu or more (S204). This current value Iu is acquired in advance as a value that a ghost is likely to occur when the value is this current value Iu or more and is stored in the memory unit 83. If the control unit 81 determines at S204 that it is Ia<Iu (that is, if the volume resistivity is larger than the predetermined value) (“No”), it continues image forming of the second image and after still in the first mode (S205, S206). On the other hand, if the control unit 81 determines at S204 that it is Ia Iu (that is, if the volume resistivity is at the predetermined value or less) (“Yes”), it switches the image forming of the second image and after to the second mode (S207, S208). At this time, extension may be started from the interval between the first sheet and the second sheet or if it cannot be made in time, the extension may be started from the interval between the second sheet and the third sheet.

As described above, if a cardboard or the like is to be used, the higher the basis weight of the transfer material P is (that is, the higher the volume resistivity is), the higher the second transfer voltage becomes, and thus, a ghost can easily occur. Therefore, similarly to the above, the second mode may be chosen if the detected current value Ia is another predetermined value or less (that is, if the volume resistivity is at another predetermined value or more).

Control in this example may be executed in combination with the determining method by the circumference or the type of the transfer material P similarly to the example 1. That is, the second mode may be made selectable only in the low-temperature and low-humidity circumstance. Alternatively, the second mode is made selectable only in the case of the predetermined coated sheet (or the predetermined cardboard) and moreover, determination using the information relating to the electrical resistance as above can be made. For example, the second mode can be selected when the coated sheet is chosen and moreover, if the detected current value is the predetermined value or more (that is, if the volume resistivity is at the predetermined value or less). Moreover, the second mode can be selected when the cardboard is chosen and moreover, if the detected current value is another predetermined value or less (that is, if the volume resistivity is at another predetermined value or more).

As described above, in this example, the control unit 81 can choose the second mode in relation to the consecutive image forming of the second transfer material P and after if the current value detected is at the predetermined value or more when the first transfer material P in the consecutive image forming passes through the secondary transfer portion N2.

As described above, according to this example, occurrence of a defective image caused by the charge history on the intermediate transfer belt 50 can be suppressed more accurately in line with the actual transfer material P.

### Example 4

Subsequently, another example of the present invention will be described. Basic constitution and operations of the image forming apparatus of this example are the same as those in the example 1. Therefore, in the image forming apparatus of this example, the same reference numerals are given to elements having the same or corresponding functions and constitutions as those of the image forming apparatus in the example 1, and detailed description will be omitted.

In the examples 1 and 2, the voltage with the same polarity with that during the primary transfer is applied to the primary transfer portion N1 in the sheet interval as the method of lowering the surface potential of the intermediate transfer belt 50.

As another method of lowering the surface potential of the intermediate transfer belt 50, the voltage with the different polarity (the same polarity with the normal charge polarity of the toner) to that during the secondary transfer may be applied to the secondary transfer portion N2 in the sheet interval. This can be employed instead of or in addition to application of the voltage with the same polarity with that during the primary transfer to the primary transfer portion N1 in the sheet interval.

For example, in the examples 1 and 2, instead of or in addition to continuous application of the same voltage to that during the primary transfer to the primary transfer portion N1 in the sheet interval in the second mode, the voltage with the different polarity to that during the secondary transfer can be applied to the secondary transfer portion N2 in the sheet interval. Specifically, in the second mode, the secondary transfer voltage with the different polarity and with an absolute value equal to that during the preceding secondary transfer in the sheet interval can be applied to the secondary transfer roller 16 in the sheet interval.

As described above, in this example, the control unit 81 causes the second applying unit 21 to apply the voltage with the different polarity to that during the secondary transfer to the secondary transfer unit 16 when the interval region between images on the intermediate transfer member 50 passes through the secondary transfer portion N2 in the second mode.

The charge history accumulated on the surface of the intermediate transfer belt 50 can be also suppressed by the constitution of this example. Therefore, occurrence of a defective image caused by the charge history on the intermediate transfer belt 50 can be suppressed.

[Others]

The present invention has been described by referring to the specific examples but the present invention is not limited to the aforementioned examples.

In the aforementioned examples, the case in which the print mode is a full-color mode is described as an example, but the control similar to the aforementioned examples can be also applied to the case in which the image forming apparatus has a black-and-white mode as a print mode. In the black-and-white mode, the intermediate transfer belt is separated from the photosensitive drum in the image forming units in some case for color such as yellow, magenta, and cyan that do not form an image s. In this case, the voltage with the same polarity with that during the primary transfer can be applied to the primary transfer unit in the sheet interval in the second mode only in the image forming unit for black that forms an image in the black-and-white mode. Moreover, there is such constitution that the photosensitive drum and the intermediate transfer belt are brought into contact in the image forming units for color even in the black-and-white mode, and the primary transfer roller is kept in contact with the photosensitive drum through the intermediate transfer belt. In this case, the voltage with the same polarity with that during the primary transfer can be applied to the primary transfer unit in the sheet interval in the second mode even in the image forming units for color or can be applied only in the image forming unit for black.

Moreover, the primary transfer voltage may be subjected to constant-current control or to constant-voltage control. Similarly, the secondary transfer voltage may be subjected to constant-current control or to constant-voltage control.

The circumstance is not limited to the absolute moisture amount but may be at least either one of temperature and humidity as long as it can be associated with ease of occurrence of a ghost.

Moreover, the information relating to the electrical resistance of the transfer material is not limited to a current value when a predetermined voltage is applied but may be a voltage value generated when a predetermined current is made to flow. Moreover, the electrical resistance itself may be acquired. Moreover, for example, the information relating to the electrical resistance of the transfer material is not limited to detection in the secondary transfer unit but it may be detected in a storage unit of the transfer material or in a conveyance path to the secondary transfer unit.

In the second mode, by extending the sheet interval by one rotation or more and two rotations or less of the intermediate transfer member, time to attenuate the surface potential of the intermediate transfer member is extended. Therefore, even if application of the primary transfer voltage or application of the secondary transfer voltage in the sheet interval is not performed, a corresponding ghost suppression effect can be obtained.

Moreover, the intermediate transfer member is not limited to an endless belt but may have a drum shape formed by extending a film over a frame body, for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-171526, filed Aug. 31, 2015, which is hereby incorporated by reference herein in its entirety.

What is claimed is:

1. An image forming apparatus comprising:
an image bearing member which bears a toner image;
a moving endless intermediate transfer belt on which the toner image subjected to primary transfer in a primary transfer portion from the image bearing member and subjected to secondary transfer in a secondary transfer portion to a recording material is temporarily borne;
a primary transfer roller arranged on an inner peripheral surface side of the intermediate transfer belt and in the primary transfer portion;
a first power supply for applying a voltage to the primary transfer roller;
a secondary transfer member arranged on an outer peripheral surface side of the intermediate transfer belt and in the secondary transfer portion;
a second power supply for applying a voltage to the secondary transfer member; and
in consecutive image forming for consecutively forming a toner image on a plurality of recording materials, an execution portion for executing either one of modes including a first mode for setting a distance between recording materials which is a distance in a moving direction of the recording materials in a region between one recording material and a subsequent recording material subsequent to the one recording material to a first length and a second mode for setting the same to a second length longer than the first length, the execution portion setting the distance between recording materials in the first mode so that a region of the intermediate transfer belt corresponding to the one recording material overlaps a region of the intermediate transfer belt corresponding to the recording material subsequent to the one recording material at least partially after one rotation, while setting the distance between recording materials in the second mode to a length of a peripheral length of the intermediate transfer belt or more and twice of the peripheral length or less so that the region of the intermediate transfer belt corresponding to the one recording material is not overlapped with the region of the intermediate transfer belt corresponding to the recording material subsequent to the one recording material after one rotation, and in the second mode, applying a voltage with a same polarity with that during the primary transfer to the primary transfer roller by the first power supply when the region of the intermediate transfer belt corresponding to the region between the recording materials passes through the primary transfer portion.

2. The apparatus according to claim 1,
wherein the execution portion applies a voltage with the same setting as that during the primary transfer to the primary transfer roller by the first power supply when the region between the recording materials of the intermediate transfer belt passes through the primary transfer portion in the second mode.

3. The apparatus according to claim 1, wherein
the execution portion applies a voltage with the same polarity and an absolute value larger than that of the voltage applied when the region between the recording materials of the intermediate transfer belt passes through the primary transfer portion in the first mode to the primary transfer roller by the first power supply when the region between the recording materials of the intermediate transfer belt passes through the primary transfer portion in the second mode.

4. The apparatus according to claim 1, wherein
the execution portion applies a voltage with the same polarity and an absolute value larger than that of the voltage applied during the primary transfer in the first mode to the primary transfer roller by the first power supply during the primary transfer in the second mode.

5. The apparatus according to claim 1, wherein
the execution portion sets a non-image portion potential on the image bearing member in the second mode to a potential with the same polarity and an absolute value smaller than that of the non-image portion potential on the image bearing member in the first mode.

6. The apparatus according to claim 1, wherein
the execution portion applies a voltage with a different polarity to that during the secondary transfer to the secondary transfer member by the second power supply when the region between the recording materials of the intermediate transfer belt passes through the secondary transfer portion in the second mode.

7. The apparatus according to claim 1, further comprising:
a sensor for detecting at least either one of a temperature or humidity around the apparatus, wherein
the execution portion executes the first mode or the second mode on the basis of a detection result of the sensor.

8. The apparatus according to claim 7, wherein
the execution portion executes the second mode when an absolute moisture amount is at a predetermined value or less as the result of detection of the sensor.

9. The apparatus according to claim 1, further comprising:
an input portion into which information relating to a type of a transfer material is input, wherein
the execution portion executes the first mode or the second mode on the basis of the information input into the input portion.

10. The apparatus according to claim 9, wherein
the execution portion executes the second mode if the information input into the input portion indicates a predetermined type of a transfer material with a predetermined basis weight or thickness or more.

11. The apparatus according to claim 1, further comprising:
a resistance detecting member for detecting information relating to electrical resistance of the transfer material, wherein
the execution portion executes the first mode or the second mode on the basis of a detection result of the resistance detecting member.

12. The apparatus according to claim 11, wherein
the resistance detecting member detects a current value flowing when the voltage is applied to the secondary transfer member by the second power supply during passage of the transfer material through the secondary transfer portion; and
the execution portion executes the second mode to the second transfer material and after if the detection result of the resistance detecting member is at a predetermined value or more when the first transfer material passes through the secondary transfer portion.

13. The apparatus according to claim 1, wherein
the intermediate transfer belt has a plurality of layers including a base layer and a surface layer.
